(19) United States
(12) Patent Application Publication
(10) Pub. No.: US 2006/0158973 A1
(43) Pub. Date: Jul. 20, 2006

(54) Actuator position control method and corresponding apparatus

(75) Inventors: Ivon Franciscus Helwegen, Eindhoven (FR); Anthonius Petrus Janssen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/562,287

(22) PCT Filed: Jun. 22, 2004
(86) PCT No.: PCT/IB04/02112

§ 371 Date: Dec. 22, 2005

(30) Foreign Application Priority Data
Jun. 26, 2003 (EP) 03300038.1

(51) Int. Cl. G11B 7/00

(52) U.S. Cl. 369/44.27

(57) ABSTRACT

The invention relates to an actuator position control method for use in a recorded information reproducing apparatus. Front, main and rear beams (or at least one main beam) are directed onto a recorded track formed on a rotating optical recording medium and respective first, second and third signals are produced in response to light reflected by said recorded track when it is scanned by the main beam. The control method comprises the steps of producing from a source of light said beam(s); scanning with the main beam the recorded track; controlling the position of said main beam with respect to the recorded track in response to position control signals, and reading the recorded information by means of a specific processing operation of the second signal. According to the invention, said method also comprises the steps of scanning in advance, with an additional beam arranged in such a way that it precedes the main one in the scanning direction, a portion of recorded track which is located in front of the portion of recorded track that will be later, after a predetermined delay, scanned by the main beam; and, on the basis of signals generated in response to the occurrence of possible defects, cancelling the effects of the variations of said corresponding signals, subsequent to variations of reflected light caused by said defects, by means of a modification of the position control signals for controlling the position of said main beam.

### FIELD OF THE INVENTION

The present invention relates to an actuator position control method for use in a recorded information reproducing apparatus in which at least one beam is directed onto a recorded track formed on a rotating optical recording medium and a corresponding signal is produced in response to light reflected by said recorded track when scanned by said beam, said method comprising the steps of:
producing from a source of light at least said beam;
scanning with said beam the recorded track;
controlling the position of said beam in response to position control signals.
   The invention may be applied to all optical disc drives that make use of a rotating optical disc (DVD, Blu-ray disc, Small form Factor Optical disc, . . . )

### BACKGROUND OF THE INVENTION

An optical disc player comprises inter alia a servo circuit in which an optical beam, emitted for example by a laser oscillator, is caused to correctly follow a track on a disc, in order to read data recorded on it (the optical disc comprises a lot of recording tracks). A radial servo provided in the disc player drives an actuator, so that, when an external disturbance is applied to the optical disc player, the actuator is driven so as to return the beam to the central line of the current track. The successive tracks on the disc being correctly followed, the data recorded on the disc are correctly read.

It can be noted here that the invention is applicable whatever the possibility of detection, for instance in case of single spot detection (such as used on DVD-ROM applications) or also with three-spots detection systems, such as three spots push-pull detection or three-spots central aperture detection. The invention will be in the following described in reference to this last system, but such a description is not intended to limit the scope of the invention.

A three-spots central aperture detection, illustrated in FIG. 1 showing an example of positional relations between five successive tracks of the recording disc and beam spots, is described for instance in the document U.S. Pat. No. 4,722,079, in which the servo circuit of the optical disc player includes three optical beams: a main beam, corresponding to the central spot 12 and provided for reading the data recorded on the current track T of the disc, and two additional beams, corresponding to the spots 11 and 13. The front beam is located in front of the main one with respect to the reading direction indicated at the top of the figure by the arrow, while the rear one is located after said main beam with respect to the reading direction, and these two additional beams generate together radial error signals used to control that the main beam follows the current track T. The reference letter “L” designates the distance between the beam spots. The radial servo provided in the disc player then drives an actuator (not shown) in reply to said radial error signals, received via an appropriate differential amplifier. When an external disturbance is applied to the optical disc player, the three beams are moved in the same direction, but the front beam and rear beam output change in phase opposition, since the parts of the front beam and the rear beam on the current track T respectively increase and decrease. As a result, the actuator is driven so as to return the main beam to the central line of said track T.

When such disturbances occur (such as fingerprints, scratches, etc), it is important that the servo system of the disc drive keeps working as good as possible, so that the drive does not loose the track. Many drives are equipped with a defect detector that keeps the servo system stiff when a defect occurs and lets it continue from the place where it is kept when the defect is over. In such a situation, the servo has to work hard to get to the correct position again, which results in some noticeable time before the system is in lock again and bits can again be detected. Additionally, it also results in power consumption and acoustical noise.

### SUMMARY OF THE INVENTION

It is therefore an object of the invention to propose a method and apparatus in which this drawback is avoided.

To this end, the invention relates to a method such as defined in the introductory paragraph of the description and which is moreover characterized in that it also comprises the steps of:
producing an additional beam;
scanning in advance, with said additional beam, a portion of recorded track which is located in front of the portion of recorded track that will be later, after a predetermined delay, scanned by the main beam;
on the basis of signals generated in response to the occurrence of possible defects detected by said additional beam on said front portion of recorded track, cancelling the effects of the variations of said corresponding signals, subsequent to variations of reflected light caused by said defects, by means of a modification of the position control signals generated for controlling the position of said main beam.

The present invention allows to solve the problem mentioned above, since the preliminary detection of the occurring defect before said defect reaches the main spot is used to immediately adapt the normalization and avoids the peaks observed in the error-signals.

The document U.S. Pat. No. 4,571,716 describes a method and apparatus for recording a data signal on a rotatable light-reflective record disc. This apparatus operates so that a write beam of light and a read beam of light are focused into the disc. A lens carriage allows to slowly move the respective points of impingement of the write and read beams. The read beam is reflected by the disc in accordance with the pattern of spaced, non-reflective pits produced on the disc by the write beam, and the reflected beam is detected to verify that the data signal was properly recorded. A defect detector then receives a pre-write signal, produced by a photodetector for a pre-write beam aligned with the write beam and the read beam and proportional to the intensity of said pre-write beam. Said pre-write beam is associated to an unrecorded portion of the disc and allows, if a defect is detected on said unrecorded portion, to ensure that the recording on the disc occurs on defect-free portions of said disc. On the contrary, in the present case, it is proposed, according to the invention, to associate an extra beam to a recorded part of the disc and to control the servo system of the disc drive in close relation with the signal detected by said extra beam.

### BRIEF DESCRIPTION OF THE DRAWINGS

The present invention will now be described, by way of example, with reference to the accompanying drawings in which:

FIG. 1 is a diagram illustrating an example of positional relations between the tracks of a disc and the beam spots, in the case of a three-spots central aperture detection;

FIG. 2 is a schematic illustration of the components of a servo system in an optical disc drive;

FIG. 3 is a graphical illustration (FIGS. 3A to 3D) of error signals when a defect appears on the recorded track of a recorded medium such as an optical disc;

FIG. 4 illustrates an embodiment of the structure according to the invention;

FIGS. 5 to 8 illustrate the action of the structure according to the invention.

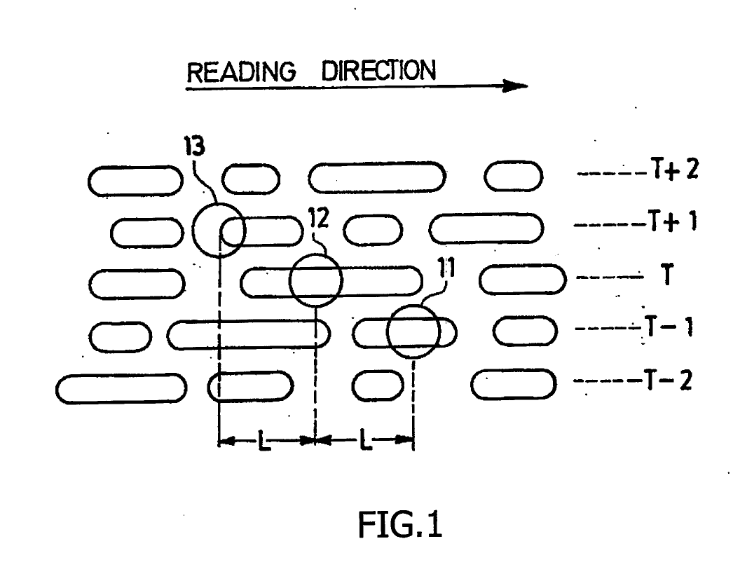

### DETAILED DESCRIPTION OF THE INVENTION

An example of embodiment of the invention will now be described below. As said above, when defects occur on optical discs, it is important that the servo system of the disc drive keeps working as good as possible. When a defect has occurred, less laser light is reflected from the disc than in a normal situation and the signal coming from photodetectors (and used as a measure for the reflected laser light) comes below a predefined threshold. A defect detector is then switched on and the servo system is kept stiff until the signal again comes above its threshold level.

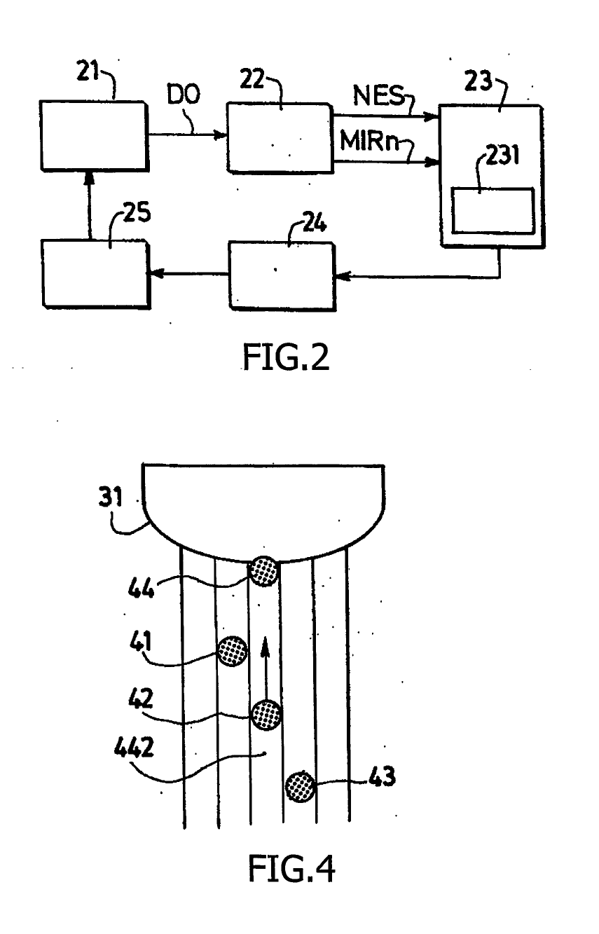

These operations take place in a servo control system. As illustrated in FIG. 2, the servo system of an optical disc drive schematically comprises an optical system 21, followed by a preprocessing circuit 22 receiving the detector outputs DO from the optical system 21 and sending its outputs to a servo control system 23, including inter alia a defect detector 231. The output of the servo control system 23 is sent to actuator drivers 24 that control actuators 25 acting themselves on the optical system 21.

In the preprocessing circuit 22, generation and normalization operations of the error signals take place, leading to normalized error signals NES that are sent towards the system 23. The system 23 also receives the mirror signal, also called MIRn when normalized to the laser power, which is the sum of the signals coming from all the detectors and is used as a measure for the reflected laser light. If a classical four-quadrant detector (including four quadrants A, B, C, D with respective photodetectors on which the reflection light from the beam spots is irradiated) is used, the normalized focus error FEn is generated for instance like indicated in the equation (1):

$$FEn = \frac{( A + B ) - ( C + D )}{A + B + C + D} \qquad ( 1 )$$

When a defect occurs, the amount of light that is returned decreases and the denominator of FEn may reach 0, which means that the error levels become very high and that the system gets unstable. To prevent from this, also dropout detection is used in the preprocessing circuit 22. When the denominator comes below a predetermined threshold, the normalization is adapted, so that the error levels do not depend on the amount of light that comes back anymore.

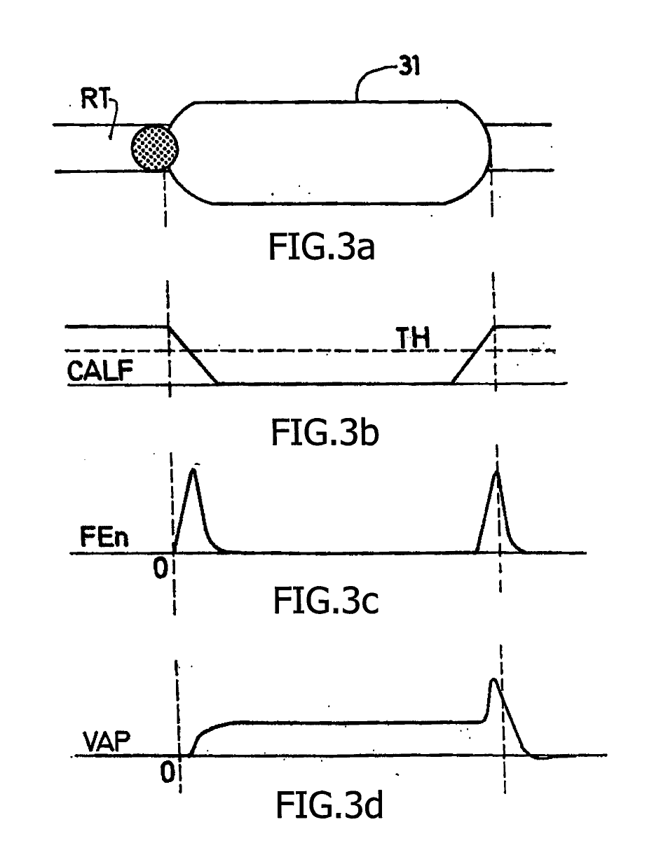

However, before the denominator reaches the threshold level, already some peaks may occur in the error-signals, at the beginning and/or at the end of the defects, and cause offsets in the actuator positions. This situation is illustrated in FIGS. 3A to 3D, which give graphical representations of error signals when a defect occurs on the recorded track RT (this defect is designated by the reference 31 in FIG. 3A): CALF (FIG. 3B) designates the sum of the signals coming from all the detectors, FEn (FIG. 3C) shows two peaks that occur in the error-signals when the signal CALF comes below the predetermined threshold TH, and FIG. 3D illustrates the corresponding variation VAP of the actuator position from the desired position.

According to the invention, an extra spot is then placed in front of the central one (in front of the single beam, in the case of a single spot detection system), as a kind of antenna for defects. This extra spot detects a defect before the system runs in to this defect, and the preprocessor or the servo controller provided in the player knows by forehand that a defect is coming. Taking into account the reading linear velocity for the recording disc, the normalization can therefore be adapted, so that the peaks in the error signals will not occur anymore.

As said above, the invention is applicable in different situations of detection, but it will hereinunder described in the case of a three spot central aperture detection system. This description however cannot be considered as a limitation of the invention. The proposed embodiment of the invention is illustrated in FIG. 4. A laser beam emitted from a laser oscillator is divided into three information reading beams through a grating for instance, and the three beams are irradiated on the disc, shown from above in FIG. 4. As also shown in FIG. 4, three beam spots 41, 42, 43 are formed on the recording disc by the three information reading beams, and, when the center spot 42 corresponding to the main beam is formed on a track 442, the two other spots 41 and 43 are formed on one side and the other one of said spot 42, and respectively in front of it and to the rear of it. The occurring defect is also designated by the reference 31 (in fact, with respect to FIG. 3, only a part of said defect is shown).

According to the invention, a fourth information reading beam is emitted, for instance from the same light source as for the three first information reading beams. This additional information reading beam is arranged in such a way that it precedes the main center beam in the scanning direction. In correspondence with said additional beam, an additional beam spot 44 is formed on the recording surface of the disc, slightly ahead from the spot 42 corresponding to the main beam. When the recording surface of the recording disc is scanned by the main center beam and its associated front and rear beams and there is a defect on said recording surface, the intensity of the light reflected at the place of said defect changes, and, thanks to the additional spot 44, this change is known before the system runs into this defect and the three reading beams are affected. More precisely, when the front end of the defect begins to be detected by the spot 44, a signal is sent towards the preprocessing circuit 22 in order to immediately adapt the normalization performed therein, so that the peaks in the error signals are compensated and offsets in the actuator positions can no longer be caused.

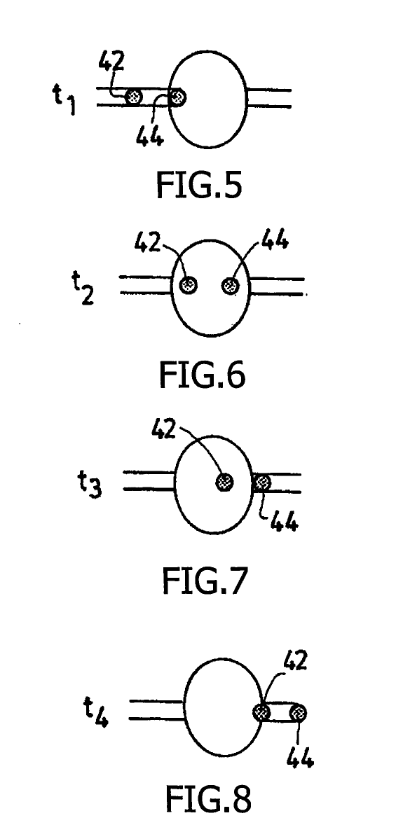

A graphical illustration of the action of the additional spot 44 may be given in FIGS. 5 to 8. In FIG. 5, at a time t1, the additional spot 44 placed ahead from the center spot 42 enters the defect: the defect is detected, but bits can still be detected and no change in the normalization has still to be performed, since error signals only concern the additional spot. However, taking into account the distance between said additional spot 44 and the center spot 42 and therefore the time difference between the signals generated in correspondence with the reflected beams associated to said spots 44 and 42, the preprocessing circuit is informed that normalization will have to be modified.

At a time t2 (FIG. 6), the center spot 42 in turn enters the defect: no bit detection is now possible, and the signal previously sent at the time t1 to the preprocessing circuit 22 (after the defect detection has occurred thanks to the additional beam) switches on the modification of the normalization in order to cancel the effects of the peak associated to the frond end of the defect.

At a time t3 (FIG. 7), the additional spot 44 goes out of the defect: the end of the defect is detected, while the center spot 42 is still within said defect, and consequently no bit detection is still possible. Finally, at a time t4 (FIG. 8), the center spot 42 in turn goes out of the defect the signal previously sent at the time t3 to the preprocessing circuit 22 (after the detection of the rear end of the defect has occurred thanks to the additional beam) switches on the modification of the normalization in order to cancel the effects of the peak associated to said rear end.

1. An actuator position control method for use in a recorded information reproducing apparatus in which at least one beam is directed onto a recorded track formed on a rotating optical recording medium and a corresponding signal is produced in response to light reflected by said recorded track when scanned by said beam, said method comprising the steps of:
producing from a source of light at least said beam;
scanning with said beam the recorded track;
controlling the position of said beam in response to position control signals;
said method being further characterized in that it also comprises the steps of:
producing an additional beam;
scanning in advance, with said additional beam, a portion of recorded track which is located in front of the portion of recorded track that will be later, after a predetermined delay, scanned by the main beam;
on the basis of signals generated in response to the occurrence of possible defects detected by said additional beam on said front portion of recorded track, cancelling the effects of the variations of said corresponding signals, subsequent to variations of reflected light caused by said defects, by means of a modification of the position control signals generated for controlling the position of said main beam.

2. An apparatus for reading an optical recording medium on which information is recorded on at least one track, said apparatus being of the type comprising:
means for generating from a light source a main beam directed onto said recorded track;
means for scanning with said beam the recorded track;
means for producing a corresponding signal in response to light reflected by said recorded track when scanned by said main beam;
means for generating position control signals from said corresponding signals;
means for controlling the position of said main beam in response to said position control signals;
means for reading the recorded information by means of a processing operator of said corresponding signal;
said apparatus being further characterized in that it also comprises, for carrying out a method according to claim 1:
means for producing an additional beam;
means for scanning in advance, with said additional beam, the portion of recorded track which is located in front of the portion of recorded track scanned after a perdetermined delay by the main beam;
means for cancelling, on the basis of signals generated in response to the occurrence of possible defects detected by said additional beam on said front portion of recorded track, the effects of the variations of said corresponding signals, subsequent to variations of reflected light caused by said defects, by means of a modification of the position control signals generated for controlling the position of said main beam.
